(19) United States
(12) Patent Application Publication
(10) Pub. No.: US 2022/0073104 A1
(43) Pub. Date: Mar. 10, 2022

(54) TRAFFIC ACCIDENT MANAGEMENT DEVICE AND TRAFFIC ACCIDENT MANAGEMENT METHOD

(71) Applicant: LG Electronics Inc., Seoul (KR)

(72) Inventor: Hansung LEE, Seoul (KR)

(21) Appl. No.: 17/259,260

(22) PCT Filed: Aug. 23, 2019
(86) PCT No.: PCT/KR2019/010738

§ 371 Date: Jan. 11, 2021

Related U.S. Application Data
(60) Provisional application No. 62/854,941, filed on May 30, 2019.

(51) Int. Cl. B60W 60/00; G08G 1/01; B60W 50/00; G08G 1/017

(52) U.S. Cl. CPC B60W 60/0016; G08G 1/0112; G08G 1/0116; B60W 2555/60; G08G 1/017; B60W 2556/65; B60W 2554/4049; B60W 50/0098

(57) ABSTRACT

The present disclosure relates to a traffic accident management method including the steps of: acquiring, by at least one processor, data as to a situation in which at least one autonomous vehicle is participated; determining, by at least one processor, at least one accident and participants comprising the autonomous vehicle, based on the data; and determining, by at least one processor, responsibility of the participants for the accident, using an artificial intelligence algorithm. A traffic accident management device may manage a traffic accident of the autonomous vehicle. The autonomous vehicle may be operatively connected to a robot. The traffic accident management device may be implemented using an artificial intelligence (AI) algorithm. The traffic accident management device may create augmented reality (AR) content.

### TECHNICAL FIELD

The present disclosure relates to a traffic accident management device and a traffic accident management method.

### BACKGROUND ART

A vehicle is an apparatus movable in a desired direction by a user seated therein. A representative example of such a vehicle is an automobile. An autonomous vehicle means a vehicle which can automatically travel without manipulation of a person.

Even in an autonomous vehicle, an accident may occur due to malfunction of a sensor, etc. When an accident occurs between autonomous vehicles, it is necessary to determine which vehicle is responsible for the accident.

### DISCLOSURE

### Technical Problem

Therefore, the present disclosure has been made in view of the above problems, and it is an object of the present disclosure to provide a traffic accident management device and a traffic accident management method capable of determining where the responsibility of a traffic accident of an autonomous vehicle lies.

Objects of the present disclosure are not limited to the above-described objects, and other objects of the present disclosure not yet described will be more clearly understood by those skilled in the art from the following detailed description.

### Technical Solution

In accordance with an aspect of the present disclosure, the above objects can be accomplished by the provision of a traffic accident management method including the steps of: acquiring, by at least one processor, data as to a situation in which at least one autonomous vehicle is participated;

determining, by at least one processor, at least one accident and participants comprising the autonomous vehicle, based on the data; and determining, by at least one processor, where responsibility of the participants for the accident, using an artificial intelligence algorithm.

In accordance with another aspect of the present disclosure, the above objects can be accomplished by the provision of a traffic accident management device including: a processor for acquiring data as to a situation in which at least one autonomous vehicle is participated, determining at least one accident and participants comprising the autonomous vehicle, based on the data, and determining responsibility of the participants for the accident, using an artificial intelligence algorithm.

Concrete matters of other embodiments will be apparent from the detailed description and the drawings.

### Advantageous Effects

In accordance with the present disclosure, one or more effects are provided as follows.

First, there may be an effect of providing safe and convenient accident management services to the interested parties of an autonomous vehicle.

Second, there is an effect of preventing occurrence of a secondary accident during an accident management procedure while eliminating traffic jam.

The effects of the present disclosure are not limited to the above-described effects and other effects which are not described herein may be derived by those skilled in the art from the description of the claims.

### DESCRIPTION OF DRAWINGS

FIG. 1 is a view referred to for explanation of a system according to an embodiment of the present disclosure.

FIG. 2 is a control block diagram of a vehicle according to an embodiment of the present disclosure.

FIG. 3 is a view referred to for explanation of a traffic accident management device according to an embodiment of the present disclosure.

FIGS. 4 to 8 are views referred to for explanation of a traffic accident management method according to an embodiment of the present disclosure.

### BEST MODE

Reference will now be made in detail to the exemplary embodiments of the present disclosure, examples of which are illustrated in the accompanying drawings. Identical or similar constituent elements will be designated by the same reference numeral even though they are depicted in different drawings. The suffixes “module” and “unit” of elements herein are used for convenience of description and thus can be used interchangeably, and do not have any distinguishable meanings or functions. In the following description of the at least one embodiment, a detailed description of known functions and configurations incorporated herein will be omitted for the purpose of clarity and for brevity. The features of the present disclosure will be more clearly understood from the accompanying drawings and should not be limited by the accompanying drawings, and it is to be appreciated that all changes, equivalents, and substitutes that do not depart from the spirit and technical scope of the present disclosure are encompassed in the present disclosure.

It will be understood that, although the terms “first”, “second”, etc. may be used herein to describe various elements, these elements should not be limited by these terms. These terms are only used to distinguish one element from another element.

It will be understood that, when an element is referred to as being “connected to” or “coupled to” another element, it may be directly connected or coupled to the other element, or intervening elements may be present. In contrast, when an element is referred to as being “directly connected to” or “directly coupled to” another element or layer, there are no intervening elements present.

The singular expressions in the present specification include the plural expressions unless clearly specified otherwise in context.

It will be further understood that the terms “comprises” or “comprising” when used in this specification specify the presence of stated features, integers, steps, operations, elements, or components, but do not preclude the presence or addition of one or more other features, integers, steps, operations, elements, components, or combinations thereof.

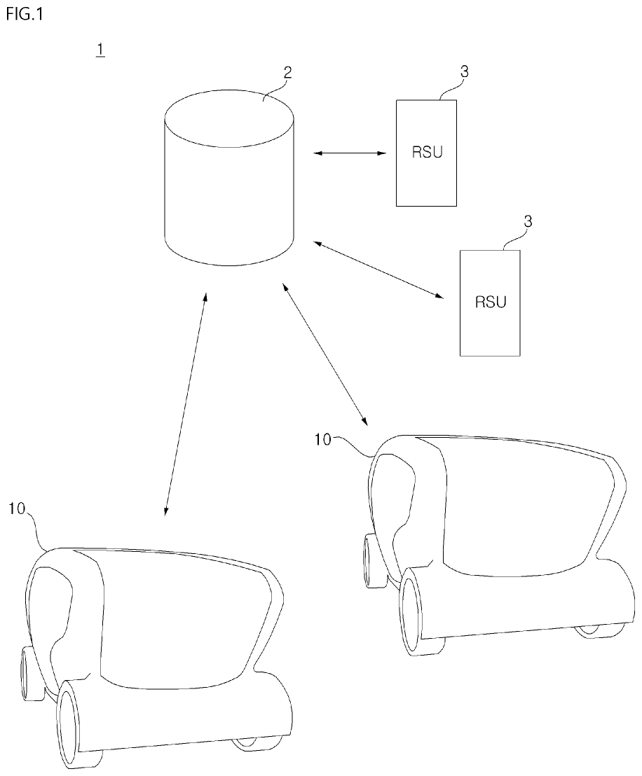

FIG. 1 is a view illustrating a vehicle according to an embodiment of the present disclosure.

Referring to FIG. 1, a system 1 may provide a vehicle 10 to the user. The system 1 may include a traffic accident management device 2, at least one road side unit 3, and at least one vehicle 10.

The traffic accident management device 2 may be embodied using at least one server. When a traffic accident of the autonomous vehicle 10 occurs, the traffic accident management device 2 may manage the traffic accident. Although the traffic accident management device 2 is described as an electronic device separate from the vehicle 10 in the present disclosure, the traffic accident management device 2 may be an electronic device included in the vehicle 10. In this case, each vehicle 10 may include the traffic accident management device 2.

The road side unit (RSU) 3 may be understood as a structure disposed around a road on which the vehicle 10 travels. The road side unit 3 may perform communication with at least one of the autonomous vehicle 10 or the traffic accident management device 2. The road side unit 3 may include a sensing device for sensing a situation of the road.

The vehicle 10 may be at least one of a manual vehicle or an autonomous vehicle. The vehicle 10 is defined as a transportation means to travel on a road or a railway line. The vehicle 10 is a concept including an automobile, a train, and a motorcycle. The vehicle 10 may be a concept including all of an internal combustion engine vehicle including an engine as a power source, a hybrid vehicle including an engine and an electric motor as a power source, an electric vehicle including an electric motor as a power source, etc.

An electronic device 100 may be included in the vehicle 10. The electronic device 100 may be included in the vehicle, for interaction thereof with the traffic accident management device 2.

Meanwhile, the vehicle 10 may co-operate with at least one robot. The robot may be an autonomous mobile robot (AMR) which is autonomously movable. The mobile robot is configured to be autonomously movable and, as such, is freely movable. The mobile robot may be provided with a plurality of sensors to enable the mobile robot to bypass an obstacle during travel and, as such, may travel while bypassing obstacles. The mobile robot may be a flying robot (for example, a drone) including a flying device. The mobile robot may be a wheeled robot including at least one wheel, to move through rotation of the wheel. The mobile robot may be a leg type robot including at least one leg, to move using the leg.

The robot may function as an apparatus for supplementing convenience of the user of the vehicle 10. For example, the robot may perform a function for transporting a load carried in the vehicle 10 to a user's final destination. For example, the robot may perform a function for guiding a way to a final destination to the user having exited the vehicle 10. For example, the robot may perform a function for transporting the user having exited the vehicle 10 to a final destination.

At least one electronic device included in the vehicle may perform communication with the robot through a communication device 220.

At least one electronic device included in the vehicle may provide, to the robot, data processed in at least one electronic device included in the vehicle. For example, at least one electronic device included in the vehicle may provide, to the robot, at least one of object data, HD map data, vehicle state data, vehicle position data or driving plan data.

At least one electronic device included in the vehicle may receive, from the robot, data processed in the robot. At least one electronic device included in the vehicle may receive at least one of sensing data produced in the robot, object data, robot state data, robot position data or movement plan data of the robot.

At least one electronic device included in the vehicle may generate a control signal further based on data received from the robot. For example, at least one electronic device included in the vehicle may compare information as to an object produced in an object detection device 210 with information as to an object produced by the robot, and may generate a control signal based on compared results. At least one electronic device included in the vehicle may generate a control signal in order to prevent interference between a travel path of the vehicle 10 and a travel path of the robot.

At least one electronic device included in the vehicle may include a software module or a hardware module (hereinafter, an artificial intelligence (AI) module) realizing artificial intelligence. At least one electronic device included in the vehicle may input acquired data to the artificial intelligence module, and may use data output from the artificial intelligence module.

The artificial intelligence module may execute machine learning of input data, using at least one artificial neural network (ANN). The artificial intelligence module may output driving plan data through machine learning of input data.

At least one electronic device included in the vehicle may generate a control signal based on data output from the artificial intelligence module.

In accordance with an embodiment, at least one electronic device included in the vehicle may receive data processed through artificial intelligence from an external device via the communication device 220. At least one electronic device included in the vehicle may generate a control signal based on data processed through artificial intelligence.

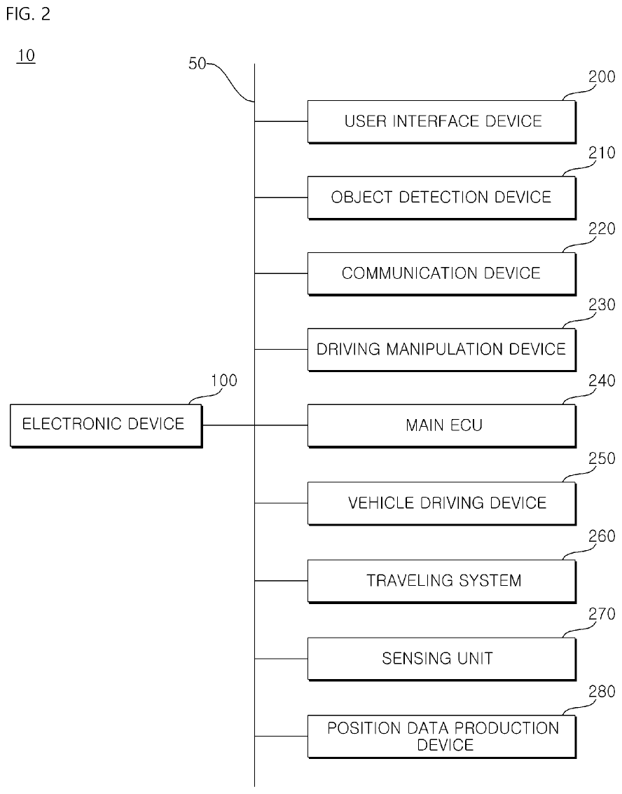

FIG. 2 is a control block diagram of the vehicle according to an embodiment of the present disclosure.

Referring to FIG. 2, the vehicle 10 may include the vehicle electronic device 100, a user interface device 200, the object detection device 210, the communication device 220, a driving manipulation device 230, a main electronic control unit (ECU) 240, a vehicle driving device 250, a traveling system 260, a sensing unit 270, and a position data production device 280.

The vehicle electronic device 100 may exchange a signal, information or data with the traffic accident management device 2 through the communication device 220. The vehicle electronic device 100 may provide a signal, information or data received from the traffic accident management device 2 to other electronic devices in the vehicle 10.

The user interface device 200 is a device for enabling communication between the vehicle 10 and the user. The user interface device 200 may receive user input, and may provide information produced in the vehicle 10 to the user. The vehicle 10 may realize user interface (UI) or user experience (UX) through the user interface device 200.

The object detection device 210 may detect an object outside the vehicle 10. The object detection device 210 may include at least one sensor capable of detecting an object outside the vehicle 10. The object detection device 210 may include at least one of a camera, a radar, a lidar, an ultrasound sensor or an infrared sensor. The object detection device 210 may provide data as to an object produced based on a sensing signal generated in the sensor to at least one electronic device included in the vehicle.

The camera may produce information as to an object outside the vehicle 10, using an image. The camera may include at least one lens, at least one image sensor, and at least one processor electrically connected to the image sensor, to process a signal received from the image sensor and to produce data as to an object based on the processed signal.

The camera may be at least one of a mono camera, a stereo camera, or an around view monitoring (AVM) camera. Using various image processing algorithms, the camera may acquire position information of an object, information as to a distance from the object or information as to a relative speed with respect to the object. For example, the camera may acquire information as to a distance from an object and information as to a relative speed with respect to the object from an acquired image, based on a variation in the size of the object according to time. For example, the camera may acquire distance information and relative speed information associated with an object through a pin hole model, road surface profiling, etc. For example, the camera may acquire distance information and relative speed information associated with an object from a stereo image acquired by a stereo camera, based on disparity information.

In order to photograph an outside of the vehicle, the camera may be mounted at a position in the vehicle where the camera can secure a field of view (FOV). In order to acquire an image in front of the vehicle, the camera may be disposed in an inner compartment of the vehicle in the vicinity of a front windshield. The camera may be disposed around a front bumper or a radiator grill. In order to acquire an image in rear of the vehicle, the camera may be disposed in the inner compartment of the vehicle in the vicinity of a back glass. The camera may be disposed around a rear bumper, a trunk or a tail gate. In order to acquire an image at a lateral side of the vehicle, the camera may be disposed in the inner compartment of the vehicle in the vicinity of at least one of side windows. Alternatively, the camera may be disposed around a side mirror, a fender, or a door.

The radar may produce information as to an object outside the vehicle 10 using a radio wave. The radar may include an electromagnetic wave transmitter, an electromagnetic wave receiver, and at least one processor electrically connected to the electromagnetic wave transmitter and the electromagnetic wave receiver, to process a received signal and to produce data as to an object based on the processed signal. The radar may be embodied through a pulse radar system or a continuous wave radar system based on a radio wave emission principle. The radar may be embodied through a frequency modulated continuous wave (FMCW) system or a frequency shift keying (FSK) system selected from continuous wave radar systems in accordance with a signal waveform. The radar may detect an object, a position of the detected object, and a distance and a relative speed with respect to the detected object by means of an electromagnetic wave on the basis of time of flight (TOF) or phase shift. The radar may be disposed at an appropriate position outside the vehicle in order to sense an object disposed at a front, rear or lateral side of the vehicle.

The lidar may produce information as to an object outside the vehicle 10, using laser light. The lidar may include an optical transmitter, an optical receiver, and at least one processor electrically connected to the optical transmitter and the optical receiver, to process a received signal and to produce data as to an object based on the processed signal. The lidar may be embodied through a time-of-flight (TOF) system and a phase shift system. The lidar may be implemented in a driven manner or a non-driven manner. When the lidar is implemented in a driven manner, the lidar may detect an object around the vehicle 10 while being rotated by a motor. When the lidar is implemented in a non-driven manner, the lidar may detect an object disposed within a predetermined range with reference to the vehicle by optical steering. The vehicle 10 may include a plurality of non-driven lidars. The lidar may detect an object, a position of the detected object, and a distance and a relative speed with respect to the detected object by means of laser light on the basis of time of flight (TOF) or phase shift. The lidar may be disposed at an appropriate position outside the vehicle in order to sense an object disposed at a front, rear or lateral side of the vehicle.

The communication device 220 may exchange a signal with a device disposed outside the vehicle 10. The communication device 220 may exchange a signal with at least one of infrastructure (for example, a server or a broadcasting station) or another vehicle. The communication device 220 may include at least one of a transmission antenna, a reception antenna, a radio frequency (RF) circuit or an RF element capable of implementing various communication protocols in order to execute communication.

The communication device 220 may communicate with a device disposed outside the vehicle 10, using a 5G (for example, new radio (NR)) system. The communication device 220 may implement V2X (V2V, V2D, V2P or V2N) communication using the 5G system.

The driving manipulation device 230 is a device for receiving user input for driving. In a manual mode, the vehicle 10 may be driven based on a signal provided by the driving manipulation device 230. The driving manipulation device 230 may include a steering input device (for example, a steering wheel), an acceleration input device (for example, an accelerator pedal), and a brake input device (for example, a brake pedal).

The main ECU 240 may control overall operation of at least one electronic device included in the vehicle 10.

The driving control device 250 is a device for electrically controlling various vehicle driving devices in the vehicle 10. The driving control device 250 may include a powertrain driving control device, a chassis driving control device, a door/window driving control device, a safety device driving control device, a lamp driving control device, and an air conditioner driving control device. The powertrain driving control device may include a power source driving control device and a transmission driving control device. The chassis driving control device may include a steering driving control device, a brake driving control device, and a suspension driving control device.

Meanwhile, the safety device driving control device may include a safety belt driving control device for safety belt control.

The vehicle driving control device 250 may be referred to as a “control electronic control unit (ECU)”.

The traveling system 260 may control motion of the vehicle 10 or may generate a signal for outputting information to the user, based on data as to an object received from the object detection device 210. The traveling system 260 may provide the generated signal to at least one of the user interface device 200, the main ECU 240 or the vehicle driving device 250.

The traveling system 260 may be a concept including an advanced driver-assistance system (ADAS). The ADAS 260 may embody an adaptive cruise control (ACC) system, an autonomous emergency braking (AEB) system, a forward collision warning (FCW) system, a lane keeping assist (LKA) system, a lane change assist (LCA) system, a target following assist (TFA) system, a blind spot detection (BSD) system, an adaptive high beam assist (HBA) system, an auto-parking system (APS), a pedestrian (PD) collision warning system, a traffic sign recognition (TSR) system, a traffic sign assist (TSA) system, a night vision (NV) system, a driver status monitoring (DSM) system, or a traffic jam assist (TJA) system.

The traveling system 260 may include an autonomous electronic control unit (ECU). The autonomous ECU may set an autonomous travel path based on data received from at least one of other electronic devices in the vehicle 10. The autonomous ECU may set an autonomous travel path based on data received from at least one of the user interface device 200, the object detection device 210, the communication device 220, the sensing unit 270, or the position data production device 280. The autonomous traveling ECU may generate a control signal to enable the vehicle 10 to travel along the autonomous travel path. The control signal generated from the autonomous traveling ECU may be provided to at least one of the main ECU 240 or the vehicle driving device 250.

The sensing unit 270 may sense a state of the vehicle. The sensing unit 270 may include at least one of an inertial navigation unit (IMU) sensor, a collision sensor, a wheel sensor, a speed sensor, a slope sensor, a weight sensor, a heading sensor, a position module, a vehicle forward/backward movement sensor, a battery sensor, a fuel sensor, a tire sensor, a handle-rotation-based steering sensor, an internal vehicle temperature sensor, an internal vehicle humidity sensor, an ultrasonic sensor, an ambient light sensor, an accelerator pedal position sensor, or a brake pedal position sensor. Meanwhile, the inertial navigation unit (IMU) sensor may include at least one of an acceleration sensor, a gyro sensor, or a magnetic sensor.

The sensing unit 270 may produce vehicle state data based on a signal generated from at least one sensor. The sensing unit 270 may acquire sensing signals as to vehicle posture information, vehicle motion information, vehicle yaw information, vehicle roll information, vehicle pitch information, vehicle collision information, vehicle direction information, vehicle angle information, vehicle speed information, vehicle acceleration information, vehicle inclination information, vehicle forward/backward movement information, battery information, fuel information, tire information, vehicle lamp information, internal vehicle temperature information, internal vehicle humidity information, a steering wheel rotation angle, ambient illumination outside the vehicle, a pressure applied to the accelerator pedal, a pressure applied to the brake pedal, etc.

In addition, the sensing unit 270 may further include an accelerator pedal sensor, a pressure sensor, an engine speed sensor, an air flow sensor (AFS), an intake air temperature sensor (ATS), a water temperature sensor (WTS), a throttle position sensor (TPS), a top dead center (TDC) sensor, a crank angle sensor (CAS), etc.

The sensing unit 270 may produce vehicle state information based on sensing data. The vehicle state information may be information produced based on data sensed by various sensors included in the vehicle.

For example, the vehicle state information may include vehicle posture information, vehicle speed information, vehicle inclination information, vehicle weight information, vehicle direction information, vehicle battery information, vehicle fuel information, vehicle tire air pressure information, vehicle steering information, internal vehicle temperature information, internal vehicle humidity information, pedal position information, vehicle engine temperature information, etc.

Meanwhile, the sensing unit may include a tension sensor. The tension sensor may generate a sensing signal based on a tension state of a safety belt.

The position data production device 280 may produce position data of the vehicle 10. The position data production device 280 may include at least one of a global positioning system (GPS) or a differential global positioning system (DGPS). The position data production device 280 may produce position data of the vehicle 10 based on a signal generated from at least one of the GPS or the DGPS. In accordance with an embodiment, the position data production device 280 may correct position data based on at least one of an inertial measurement unit (IMU) of the sensing unit 270 or a camera of the object detection device 210.

The position data production device 280 may be referred to as a “position measurement device”. The position data production device 280 may be referred to as a “global navigation satellite system (GNSS)”.

The vehicle 10 may include an inner communication system 50. Plural electronic devices included in the vehicle 10 may exchange a signal via the inner communication system 50. Data may be included in the signal. The inner communication system 50 may utilize at least one communication protocol (for example, CAN, LIN, FlexRay, MOST, or Ethernet).

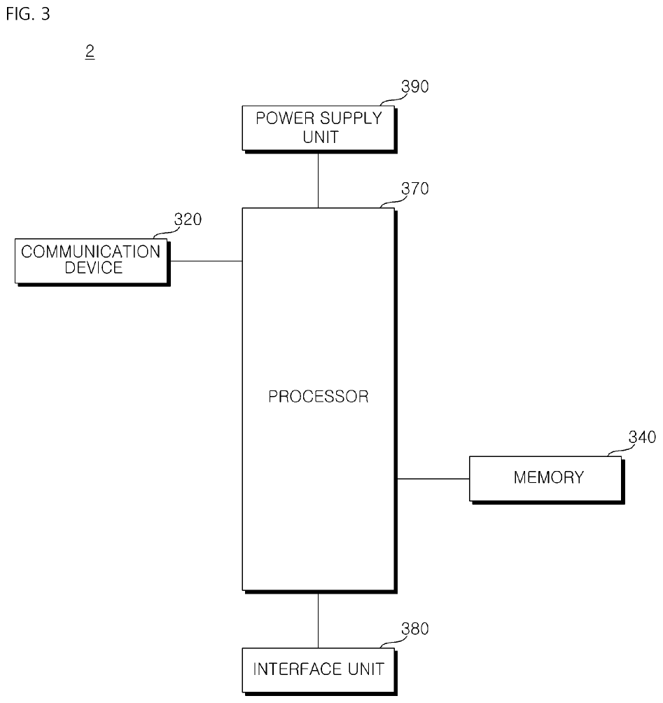

FIG. 3 is a control block diagram of the electronic device according to an embodiment of the present disclosure.

Referring to FIG. 3, the traffic accident management device 2 may include a communication device 320, a memory 340, a processor 370, an interface unit 180, and a power supply unit 390.

The communication device 320 may exchange a signal with the vehicle 10 and a communication device disposed outside the vehicle 10. The vehicle-outside communication device may include a road side unit 3 and an external server.

The communication device 320 may include at least one of a transmission antenna, a reception antenna, a radio frequency (RF) circuit or an RF element capable of implementing various communication protocols in order to execute communication.

The communication device 320 may communicate with the vehicle 10 and the vehicle-outside communication device, using a 5G (for example, new radio (NR)) system. In the following description, the vehicle-outside communication device according to the embodiment of the present disclosure may be described on the basis of the road side unit 3.

The memory 340 is electrically connected to the processor 370. The memory 340 may store basic data as to units, control data for unit operation control, and input and output data. The memory 340 may store data processed by the processor 370. The memory 340 may be constituted in a hardware manner by at least one of a read only memory (ROM), a random access memory (RAM), an erasable programmable read-only memory (EPROM), a flash drive, or a hard drive. The memory 340 may store various data for overall operation of the traffic accident management device 2 including a program for processing or controlling the processor 370, etc. The memory 340 may be integrated with the processor 370. In accordance with an embodiment, the memory 340 may be classified into a lower-level configuration of the processor 370.

The interface unit 180 may exchange a signal with at least one electronic device included in the vehicle 10 in a wired or wireless manner. The interface unit 180 may exchange a signal in a wired or wireless manner with at least one of the object detection device 210, the communication device 220, the driving manipulation device 230, the main ECU 140, the vehicle driving device 250, the traveling system 260, the sensing unit 270, or the position data production device 280. The interface unit 280 may be constituted by at least one of a communication module, a terminal, a pin, a cable, a port, a circuit, an element, or a device.

The power supply unit 390 may supply electric power to the traffic accident management device 2. The power supply unit 390 may receive electric power from a power source (for example, a battery) included in the vehicle 10 and, as such, may supply electric power to each unit of the traffic accident management device 2. The power supply unit 390 may operate in accordance with a control signal supplied from the main ECU 140. The power supply unit 390 may be embodied using a switched-mode power supply (SMPS).

The processor 370 may be electrically connected to the memory 340, the interface unit 180, and the power supply unit 390, and, as such, may exchange a signal therewith. The processor 370 may be embodied using at least one of application specific integrated circuits (ASICs), digital signal processors (DSPs), digital signal processing devices (DSPDs), programmable logic devices (PLDs), field programmable gate arrays (FPGAs), controllers, microcontrollers, microprocessors, or electrical units for execution of other functions.

The processor 370 may be driven by electric power supplied from the power supply unit 390. In a state in which electric power from the power supply unit 390 is supplied to the processor 370, the processor 370 may receive data, process the data, generate a signal, and supply the signal.

The processor 370 may receive information from other electronic devices in the vehicle 10 via the interface unit 180. The processor 370 may supply a control signal to other electronic devices in the vehicle 10 via the interface unit 180.

The processor 370 may acquire data as to a situation in which at least one autonomous vehicle is participated. The processor 370 may acquire first data from at least one electronic device included in the autonomous vehicle 10. For example, the processor 370 may acquire the first data from at least one of the object detection device 210 or the sensing unit 270 included in the autonomous vehicle 10. The first data may include at least one of position information, speed information, heading information, acceleration information, speed reduction information, steering information, brake information or impact amount information of the autonomous vehicle 10. The first data may be data as to an object around the autonomous vehicle 10. The processor 370 may acquire second data from at least one electronic device included in another vehicle disposed around the autonomous vehicle. The other vehicle may be another autonomous vehicle. For example, the processor 370 may acquire the second data from at least one of an object detection device or a sensing unit included in the other autonomous vehicle. The second data may include sensing data representing sensing of the autonomous vehicle 10. The second data may include at least one of position information, speed information, heading information, acceleration information, speed reduction information, steering information, brake information or impact amount information of the other autonomous vehicle.

The processor 370 may acquire third data from at least one external communication device disposed around the autonomous vehicle 10. The third data may be sensing data acquired by the road side unit 3 while representing sensing of the autonomous vehicle 10. The third data may be sensing data acquired by an external server while representing sensing of the autonomous vehicle 10.

The processor 370 may acquire third data from at least one road side unit 3 disposed around the autonomous vehicle 10. The third data may include at least one of sensing data (for example, image data) representing sensing of the autonomous vehicle 10, signal sign data, or map data.

The processor 370 may determine at least one accident and participants comprising the autonomous vehicle 10, based on data as to a situation of the autonomous vehicle 10. The processor 370 may determine whether or not an accident of the autonomous vehicle 10 has occurred, based on the first data acquired from the autonomous vehicle 10, the second data acquired from the other autonomous vehicle or the third data acquired from the road side unit. For example, the processor 370 may determine whether or not an accident of the autonomous vehicle 10 has occurred, based on speed information, acceleration information, speed reduction information, brake information, and impact amount information of the autonomous vehicle 10, or image data acquired from the road side unit.

The processor 370 may determine responsibility of the participants for the accident, using an artificial intelligence algorithm.

The processor 370 may reconstruct the situation when the accident occurs, through a simulation, based on at least one of the first data acquired from the autonomous vehicle 10, the second data acquired from the other autonomous vehicle or the third data acquired from the road side unit.

For example, the processor 370 may reconstruct the situation when the accident occurs, through a simulation, by synthesizing and editing image data acquired from the autonomous vehicle 10, image data acquired from the other autonomous vehicle, and image data acquired from the road side unit.

For example, the processor 370 may map the autonomous vehicle 10 and objects around the autonomous vehicle 10 in a map in chronological order. The processor 370 may reconstruct the situation when the accident occurs, through a simulation, in accordance with mapping of the autonomous vehicle 10 and objects around the autonomous vehicle 10. Meanwhile, information as to the objects around the autonomous vehicle 10 may be produced based on at least one of the first data acquired from the autonomous vehicle 10, the second data acquired from the other autonomous vehicle, or the third data acquired from the road side unit.

For example, the processor 370 may produce a top-view image with reference to an image of the autonomous vehicle 10, based on at least one of the first data acquired from the autonomous vehicle 10, the second data acquired from the other autonomous vehicle, or the third data acquired from the road side unit. In accordance with production of the top-view image, the processor 370 may reconstruct the situation when the accident occurs, through a simulation. The top-view image may be a video image including a posture image of the steered wheels of the autonomous vehicle.

The processor 370 may input data as to a situation of the autonomous vehicle 10 and traffic law data to the artificial intelligence (AI) algorithm, and may perform machine learning of the input data and, as such, may determine where the responsibility of the participants for the accident lies. The processor 370 may further input past traffic accident history data to the artificial intelligence algorithm, and may perform machine learning of the input data and, as such, may determine where the responsibility of the participants for the accident lies.

The artificial intelligence algorithm may execute machine learning of input data, using at least one artificial neural network (ANN).

The processor 370 may execute a routine for preventing a secondary accident following the accident.

After occurrence of the accident, the processor 370 may determine whether or not the autonomous vehicle 10 is movable. Upon determining that the autonomous vehicle 10 is movable, the processor 370 may create an avoidance path of the autonomous vehicle 10. The processor 370 may provide a control signal to enable the autonomous vehicle 10 to travel along the avoidance path.

The processor 370 may calculate an estimated collision time taken for another vehicle following the autonomous vehicle 10 to collide with the autonomous vehicle 10. The processor 370 may compare the estimated collision time with a avoidance time taken for the autonomous vehicle 10 to avoid an accident site along the avoidance path. The processor 370 may provide a control signal to enable the autonomous vehicle 10 to travel along the avoidance path when the avoidance time is not shorter than the estimated collision time.

The traffic accident management device 2 may include at least one printed circuit board (PCB). The memory 140, the interface unit 180, the power supply unit 190 and the processor 370 may be electrically connected to the printed circuit board.

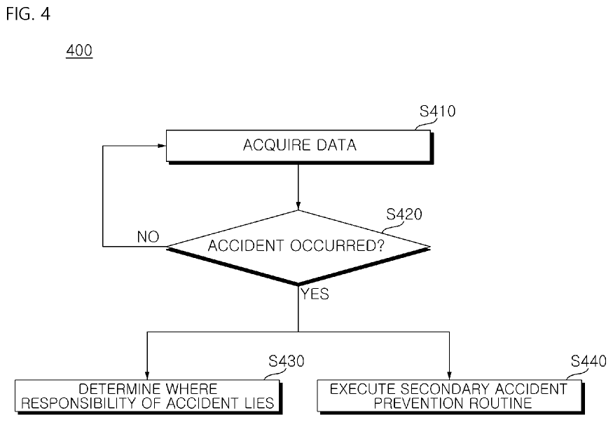

FIG. 4 is a view referred to for explanation of a traffic accident management method S400 according to an embodiment of the present disclosure.

Referring to FIG. 4, the processor 370 may acquire data as to a situation of the autonomous vehicle 10 (S410). The data acquisition step S410 may include the steps of acquiring, by at least one processor 370, first data from at least one electronic device included in the autonomous vehicle 10, acquiring, by at least one processor 370, second data from at least one electronic device included in another vehicle disposed around the autonomous vehicle 10, and acquiring, by at least one processor, third data from at least one road side unit disposed around the autonomous vehicle.

The processor 370 may determine whether or not an accident of the autonomous vehicle 10 has occurred, based on the data as to the situation of the autonomous vehicle 10 (S420).

Upon determining that an accident has occurred in the autonomous vehicle 10, the processor 370 may determine where the responsibility of the participants for the accident lies, using an artificial intelligence algorithm (S430).

The step S430 of determining where the responsibility of the participants for the accident lies may include the step of reconstructing the situation when the accident occurs, through a simulation, based on at least one of the first data acquired from the autonomous vehicle 10, the second data acquired from the other autonomous vehicle or the third data acquired from the road side unit. For example, the reconstruction step may include the step of mapping the autonomous vehicle 10 and objects around the autonomous vehicle 10 in a map in chronological order. In this case, information as to the objects around the autonomous vehicle 10 may be produced based on at least one of the first data, the second data, or the third data. For example, the reconstruction step may include the step of producing a top-view image with reference to an image of the autonomous vehicle 10, based on at least one of the first data, the second data, or the third data. In this case, the top-view image may be a video image including a posture image of the steered wheels of the autonomous vehicle 10.

The step S430 of determining where the responsibility of the participants for the accident lies may include the steps of inputting, by at least one processor 370, data as to a situation of the autonomous vehicle 10 and traffic law data to the artificial intelligence algorithm, performing, by at least one processor 370, machine learning of the input data, and determining, by at least one processor 370, where the responsibility of the participants for the accident lies, based on results of the machine learning. The step S430 of determining where the responsibility of the participants for the accident lies may include the steps of further inputting, by at least one processor 370, past traffic accident history data to the artificial intelligence algorithm, performing, by at least one processor 370, machine learning of the input data, and determining, by at least one processor 370, where the responsibility of the participants for the accident lies, based on results of the machine learning.

Upon determining that an accident has occurred in the autonomous vehicle 10, the processor 370 may execute a routine for preventing a secondary accident following the accident (S430).

The step S430 of executing the secondary accident prevention routine may include the steps of determining, by at least one processor 370, whether or not the autonomous vehicle 10 is movable after occurrence of the accident, creating, by at least one processor 370, an avoidance path of the autonomous vehicle 10, and providing, by at least one processor 370, a control signal to enable the autonomous vehicle 10 to travel along the avoidance path.

The step S430 of executing the secondary accident prevention routine may include the steps of calculating, by at least one processor 370, an estimated time taken for another vehicle following the autonomous vehicle 10 to collide with the autonomous vehicle 10, and comparing, by at least one processor 370, the estimated collision time with a time taken for the autonomous vehicle 10 to avoid an accident site along the avoidance path. in this case, the step of providing the control signal may include the step of providing, by at least one processor 370, the control signal when the avoidance time is not shorter than the estimated collision time.

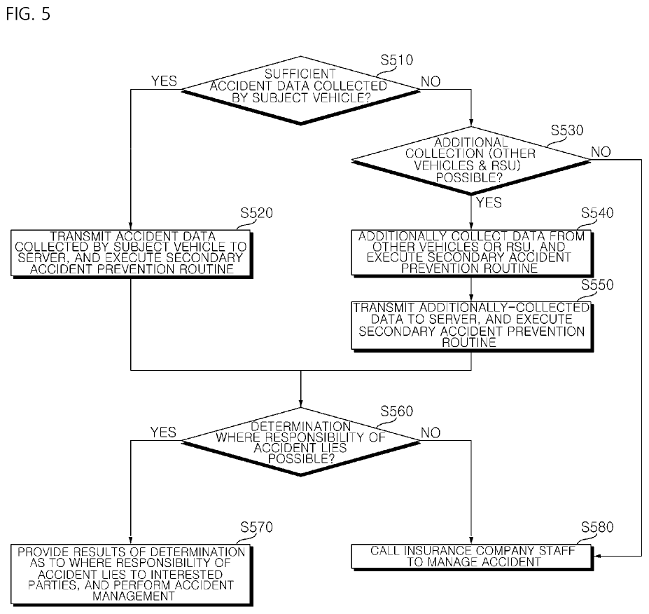

FIGS. 5 to 8 are views referred to for explanation of a traffic accident management method according to an embodiment of the present disclosure. FIGS. 5 to 8 illustrate flowcharts in the case in which the traffic accident management device is included in the vehicle 10.

Referring to FIG. 5, the processor 370 may determine whether or not there is sufficient accident data collected by the vehicle 10 (S510). Whether or not there is sufficient accident data may be determined in accordance with whether or not there are movement traces of the vehicle 10 and surrounding objects, signal sign information, etc. collected for a predetermined time before the occurrence of the accident. Upon determining, in step S510, that there are sufficient data, the processor 370 may transmit accident data collected by the vehicle 10 to the server 2, and may execute the secondary accident prevention routine (S520). Upon determining, in step S520, that there is insufficient data, the processor 370 may determine whether or not additional data collection is possible (S530). Upon determining, in step S530, that additional data collection is possible, the processor 370 may additionally collect data from the other vehicle or the road side unit, and may execute the secondary accident prevention routine (S540). After completion of the additional data collection, the processor 370 may transmit the data to the server 2, and may execute the secondary accident prevention routine (S550).

The processor 370 may determine where the responsibility of the participants for the accident lies (S560). The determination as to where the responsibility of the accident lies may be achieved by matching the collected accident data with past accident responsibility determination cases stored in the server. When it is possible to determine, in step S560, where the responsibility of the participants for the accident lies, the processor 370 may provide, to the interested parties, results of the determination as to where the responsibility of the participants for the accident lies, and may perform accident management (S570). When it is impossible to determine, in step S560, where the responsibility of the participants for the accident lies, the processor 370 may call staff of an insurance company (S580). The called insurance company staff may conduct a subsequent accident management.

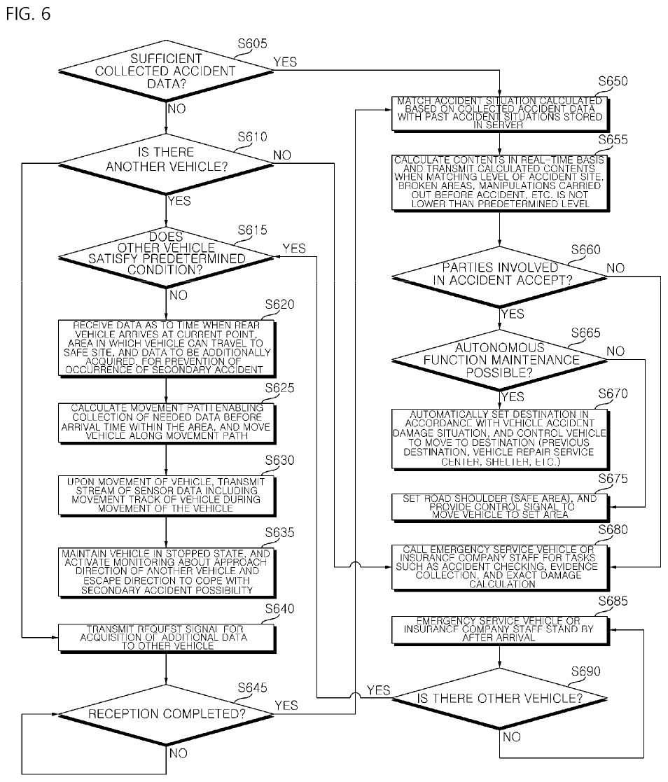

Referring to FIG. 6, the processor 370 may determine whether or not there is sufficient collected accident data (S605). Upon determining, in step S605, that there is insufficient collected accident data, the processor 370 may determine whether or not there is another vehicle (S610). Upon determining, in step S610, that there is another vehicle, the processor 370 may determine whether or not the other vehicle satisfies a predetermined condition (S615). For example, the processor 370 may determine whether or not the other vehicle is disposed within a predetermined radius around the subject vehicle. Upon determining, in step S615, that the other vehicle does not satisfy the predetermined condition, the processor 370 may receive, from the server, data as to the time when a rear vehicle arrives at the current point, an area in which the vehicle can travel to a safe site, and data to be additionally acquired, for prevention of occurrence of a secondary accident (S620). The processor 370 may calculate a movement path enabling collection of needed data before the arrival time within the area, and may move the vehicle 10 along the movement path (S625). Upon movement of the vehicle 10, the processor 370 may transmit a stream of sensor data including a movement track of the vehicle 10 during movement of the vehicle 10 (S630). The processor 370 may collect accident data, and may trace vehicle movement of an accident site. The processor 370 may maintain the vehicle 10 in a stopped state, and may activate monitoring about an approach direction of another vehicle and an avoidance direction to cope with a secondary accident possibility (S635).

Upon determining, in step S605, that there is sufficient collected data, the processor 370 may match the accident situation calculated based on the collected accident data with past accident situations stored in the server 2 (S650). When a matching level of the accident site, broken areas, manipulations carried out before the accident, etc. is not lower than a predetermined level, the processor 370 may calculate contents associated with the accident situation on a real-time basis, and may transmit the calculated contents (S655). The processor 370 may determine whether or not the parties involved in the accident accept the calculated contents (S660). Upon determining, in step S660, that the parties involved in the accident accept the calculated contents, the processor 370 may determine whether or not an autonomous function can be maintained (S665). Upon determining, in step S665, that the autonomous function can be maintained, the processor 370 may automatically set a destination in accordance with a vehicle accident damage situation, and may control the vehicle 10 to move to the destination. Here, the automatically-set destination may be at least one of a previous destination, a vehicle repair service center, or a shelter. Upon determining, in step S665, that the autonomous function cannot be maintained, the processor 370 may set a safe area (for example, a road shoulder), and may provide a control signal to move the vehicle to the set area (S675).

On the other hand, upon determining, in step S660, that the parties involved in the accident do not accept the calculated contents, the processor 370 may call an emergency service vehicle or insurance company staff for tasks such as accident checking, evidence collection, and exact damage calculation (S680). An emergency service vehicle or insurance company staff may stand by after arrival (S685). The processor 370 may determine whether or not whether or not there is another vehicle (S690). Upon determining that there is another vehicle, the processor 370 may proceed to step S615. Upon determining that there is no other vehicle, the processor 370 may proceed to step S685.

On the other hand, upon determining, in step S610, that there is no other vehicle, the processor 370 may proceed to step S680.

On the other hand, upon determining, in step S615, that the other vehicle satisfies the predetermined condition, the processor 370 may transmit, to the other vehicle, a request signal for acquisition of additional data. The processor 370 may determine whether or not reception of additional data has been completed (S645). Upon determining, in step S645, that reception of additional data has been completed, the processor 370 may proceed to step S650.

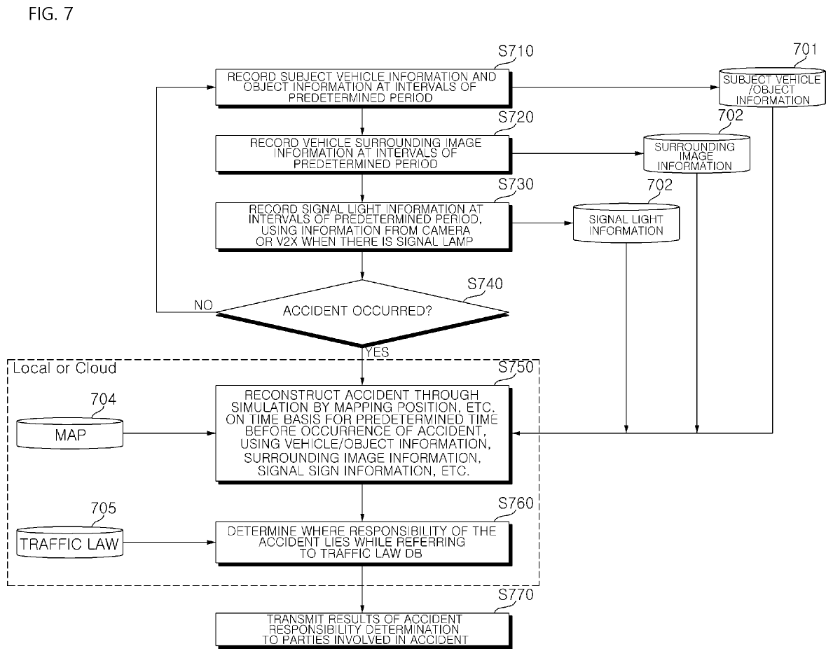

Referring to FIG. 7, the processor 370 may record vehicle information and vehicle surrounding object information in a first database 701 at intervals of a predetermined period (S710). The first database 701 may be classified into a lower-level configuration of the memory 340. The vehicle information may be explained as information associated with a motion state of the vehicle such as position, speed, heading, acceleration, etc. of the vehicle. The object information may be set by information as to motion states of objects such as position, speed, heading, acceleration, etc. of vehicle surrounding objects detected and traced using a sensor, such as a vehicle, a two-wheeled vehicle, a pedestrian, and an obstacle. The processor 370 may record vehicle surrounding image information in a second database 702 at intervals of a predetermined period (S720). The second database 702 may be classified into a lower-level configuration of the memory 340. When there is a signal lamp, the processor 370 may record signal light information in a third database 703 at intervals of a predetermined period, using information from a camera or V2X (S730). The third database 703 may be classified into a lower-level configuration of the memory 340.

The processor 370 may determine whether or not an accident has occurred (S740). Upon determining that an accident has occurred, the processor 370 may reconstruct the accident through a simulation by mapping position, etc. on a time basis for a predetermined time before the occurrence of the accident, using vehicle/object information, surrounding image information, signal sign information, etc. (S750). The processor 370 may reconstruct the accident through a simulation by receiving map data from a map database 704, and reflecting various information in the map data. The processor 370 may determine where the responsibility of the participants for the accident lies (S760). The processor 370 may receive a traffic law from a traffic law database 705, and may determine where the responsibility of the participants for the accident lies by referring to the traffic law. The processor 370 may transmit results of the accident responsibility determination to the parties involved in the accident (S770).

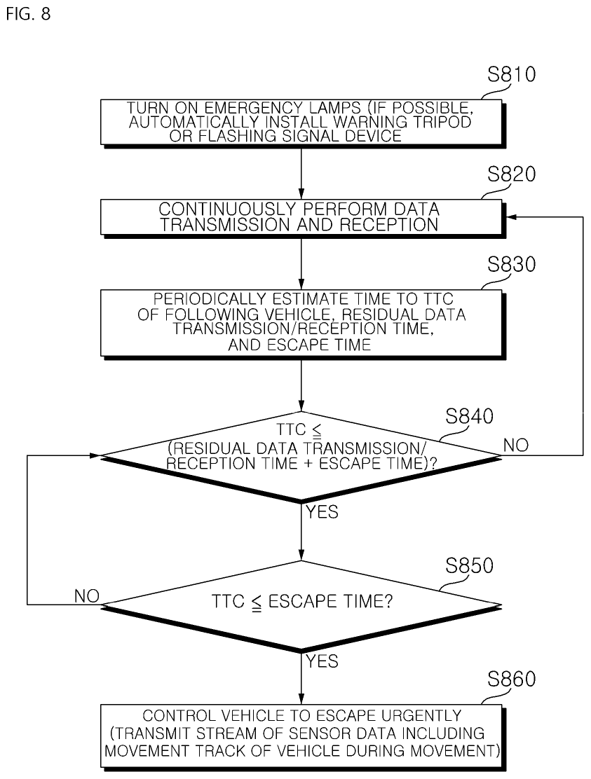

Referring to FIG. 8, the processor 370 may turn on emergency lamps after occurrence of the accident (S810). In accordance with an embodiment, the processor 370 may automatically install a warning tripod or a flashing signal device. The processor 370 may continuously perform data transmission and reception with an external device (for example, a server, another vehicle, or a user terminal) (S820). The processor 370 may periodically estimate a time to collision (TTC) of a following vehicle, a residual data transmission/reception time, and an avoidance time. The TTC may be explained as an estimated time taken for another vehicle to collide with the subject vehicle. The residual data transmission/reception time may be explained as an estimated residual time taken to receive accident-associated data from another vehicle or a road side unit or to complete transmission of the accident-associated data to the server. The avoidance time may be explained as a time taken to move the subject vehicle such that the subject vehicle can avoid a vehicle expected to collide with the subject vehicle. An extra time may be added to the avoidance time, for leeway avoidance of the subject vehicle.

The processor 370 may determine whether or not the TTC is not longer than a sum of the residual data transmission/reception time and the avoidance time (S840). Upon determining that the TTC is not longer than the sum of the residual data transmission/reception time and the avoidance time, the processor 370 may determine whether or not the TTC is not longer than the avoidance time (S850). Since the TTC is variable in accordance with a braking situation of a following vehicle, the processor 370 may continuously perform data transmission and reception while continuously monitoring a value of the TTC. Upon determining, in step S850, that the TTC is not longer than the avoidance time, the processor 370 may control the vehicle to avoid urgently (S860). The processor 370 may transmit a stream of sensor data including a movement track of the vehicle during movement of the vehicle.

When an accident has occurred, the vehicle associated with the accident may transmit vehicle information associated with the accident to the server 2. The server 2 may be an insurance company server or a vehicle company server. The accident-associated vehicle information may include at least one of a collision position of the vehicle, a collision intensity of the vehicle, driving unit sensing information of the vehicle, sensing information as to a vehicle surrounding environment (a front camera, a black box, a radar, lidar, etc.), or sensing information acquired by a surrounding vehicle through V2X.

The server 2 may acquire data including data acquired for a predetermined time before an accident occurrence time of each accident-occurred vehicle and for a predetermined time after the accident occurrence time of the accident-occurred vehicle, and may calculate a fault ratio based on the acquired data.

The fault ratio may be determined based on results of learning of an artificial intelligence algorithm loaded in the server on the basis of at least one of the acquired data, traffic law data or an accident database (DB). Information associated with the determined fault ratio may be transmitted to each accident-occurred vehicle. The vehicle 10 may provide the fault ratio information received from the server 2 through an output unit disposed in the vehicle. The accident DB information may be information produced in an insurance company or an institution collecting associated information. The accident DB may include accident history information of the other vehicle. In the accident history information, a fault ratio may be included.

For example, when an accident has occurred, the server may check whether or not there is accident history information of the other vehicle similar to the information of the occurred accident, based on the accident history information of the other vehicle acquired from the accident DB.

The output unit disposed in the vehicle may be a display (a head-up display, a dashboard, or a center information display) or a voice output unit.

The parties involved in the accident may select whether or not the fault ratio provided through the output unit is accepted. When the involved parties select that the fault ratio is accepted, information as to confirmation of the fault ratio by the involved parties may be transmitted to the insurance company. The insurance company may calculate an insurance payment based on the transmitted information. When the involved parties select that the fault ratio is unaccepted, additional guidance information may be provided based on selected results. Insurance company staff may be called and requested to directly come to an accident site. Alternatively, information may be further collected from surrounding vehicles or objects, and a fault ratio may be again provided through secondary learning.

Upon calculating a fault ratio, the server 2 may further acquire surrounding environment data including data acquired for a predetermined time before an accident occurrence time of each accident-occurred vehicle and for a predetermined time after the accident occurrence time of the accident-occurred vehicle, when data for calculation of a fault ratio is insufficient, and may calculate a fault ratio based on the acquired data. Here, the surrounding environment data may be sensor information acquired by a surrounding vehicle or sensor information acquired by a surrounding sensing device (CCTV, RSU, etc.) for a predetermined time after the accident occurrence time of the accident-occurred vehicle.

For example, when the insurance company server transmits information as to a calculated fault ratio to the accident-occurred vehicle, the vehicle may output the information received from the insurance company server to a center information display (CID) included in an instrument panel of the vehicle. The CID may be integrated with a touch input unit or may form a co-layer structure together with the touch input unit and, as such, may be embodied as a touchscreen. The CID may further include a gesture input unit or a voice input unit. The information output to the CID may be information as to a query about whether or not the fault ratio of the vehicle is accepted. The parties involved in the accident may input a selection value as to whether or not the fault ratio is accepted, through the touch input unit of the CID.

The accident type of the vehicle may be mainly classified into the case in which an accident occurs between vehicles, the case in which an accident occurs between a vehicle and an object, and the case in which an accident occurs between a vehicle and a pedestrian. When an accident occurs between vehicles, the responsibility rates of the vehicles may be different. When the accident-occurred vehicle is an autonomous vehicle, the person-vehicle responsibility ratio may be varied in accordance with a control right rate of the driver.

The present disclosure as described above may be embodded as computer-readable code, which can be written on a program-stored recording medium. The recording medium that can be read by a computer includes all kinds of recording media on which data that can be read by a computer system is written. Examples of recording media that can be read by a computer may include a hard disk drive (HDD), a solid state drive (SSD), a silicon disk drive (SDD), a read only memory (ROM), a random access memory (RAM), a CD-ROM, a magnetic tape, a floppy disk, an optical data storage, etc., and may include an embodiment having the form of a carrier wave (for example, transmission over the Internet). In addition, the computer may include a processor or a controller. Accordingly, it will be apparent to those skilled in the art that various modifications and variations can be made in the present disclosure without departing from the spirit or scope of the disclosure. Thus, it is intended that the present disclosure cover the modifications and variations of this disclosure provided they come within the scope of the appended claims and their equivalents.

1. A traffic accident management method comprising:
acquiring, by at least one processor, data as to a situation in which at least one autonomous vehicle is participated;
determining, by at least one processor, at least one accident and participants comprising the autonomous vehicle, based on the data; and
determining, by at least one processor, responsibility of the participants for the accident, using an artificial intelligence algorithm.

2. The traffic accident management method according to claim 1, wherein the acquiring data comprises:
acquiring, by at least one processor, first data from at least one electronic device mounted in the autonomous vehicle;
acquiring, by at least one processor, second data from at least one electronic device mounted in another vehicle disposed around the autonomous vehicle; and
acquiring, by at least one processor, third data from at least one road side unit (RSU) disposed around the autonomous vehicle.

3. The traffic accident management method according to claim 2, wherein the determining responsibility of the participants for the accident comprises reconstructing, by at least one processor, a situation when the accident occurs, through a simulation, based on at least one of the first data, the second data or the third data.

4. The traffic accident management method according to claim 3, wherein:
the reconstructing comprises mapping, by at least one processor, the autonomous vehicle and objects around the autonomous vehicle in a map in chronological order; and
information as to the objects around the autonomous vehicle is produced based on at least one of the first data, the second data, or the third data.

5. The traffic accident management method according to claim 3, wherein:
the reconstructing comprises producing, by at least one processor, a top-view image with reference to an image of the autonomous vehicle, based on at least one of the first data, the second data, or the third data; and
the top-view image is a video image including a posture image of steered wheels of the autonomous vehicle.

6. The traffic accident management method according to claim 1, wherein the determining responsibility of the participants for the accident comprises:
inputting, by at least one processor, data as to a situation of the autonomous vehicle and traffic law data to the artificial intelligence algorithm,
performing, by at least one processor, machine learning of the input data, and
determining, by at least one processor, where the responsibility of the participants for the accident lies, based on results of the machine learning.

7. The traffic accident management method according to claim 6, wherein the determining responsibility of the participants for the accident comprises:
further inputting, by at least one processor, past traffic accident history data to the artificial intelligence algorithm,
performing, by at least one processor, machine learning of the input data, and
determining, by at least one processor, where the responsibility of the participants for the accident lies, based on results of the machine learning.

8. The traffic accident management method according to claim 1, further comprising:
executing, by at least one processor, a routine for preventing a secondary accident following the accident.

9. The traffic accident management method according to claim 8, wherein the executing the routine comprises:
determining, by at least one processor, whether the autonomous vehicle is movable after occurrence of the accident;
generating, by at least one processor, an avoidance path of the autonomous vehicle; and
providing, by at least one processor, a control signal to enable the autonomous vehicle to travel along the avoidance path.

10. The traffic accident management method according to claim 9, wherein:
the executing the routine comprises:
calculating, by at least one processor, an estimated collision time taken for another vehicle following the autonomous vehicle to collide with the autonomous vehicle, and
comparing, by at least one processor, the estimated collision time with an avoidance time taken for the autonomous vehicle to avoid an accident site along the avoidance path; and
the providing the control signal comprises providing, by at least one processor, the control signal when the avoidance time is not shorter than the estimated collision time.

11. A traffic accident management device comprising:
a processor configured to:
acquire data as to a situation in which at least one autonomous vehicle is participated,
determine at least one accident and participants comprising the autonomous vehicle, based on the data, and
determine responsibility of the participants for the accident, using an artificial intelligence algorithm.

12. The traffic accident management device according to claim 11, wherein the processor is configured to:
acquire first data from at least one electronic device mounted in the autonomous vehicle;
acquire second data from at least one electronic device mounted in another vehicle disposed around the autonomous vehicle; and
acquire third data from at least one road side unit (RSU) disposed around the autonomous vehicle.

13. The traffic accident management device according to claim 12, wherein the processor is configured to reconstruct a situation when the accident occurs, through a simulation, based on at least one of the first data, the second data or the third data.

14. The traffic accident management device according to claim 13, wherein:
the processor is configured to perform mapping the autonomous vehicle and objects around the autonomous vehicle in a map in chronological order; and
information as to the objects around the autonomous vehicle is produced based on at least one of the first data, the second data, or the third data.

15. The traffic accident management device according to claim 13, wherein:
the processor is configured to produce a top-view image with reference to an image of the autonomous vehicle, based on at least one of the first data, the second data, or the third data; and
the top-view image is a video image including a posture image of steered wheels of the autonomous vehicle.

16. The traffic accident management device according to claim 11, wherein the processor is configured to:
input data as to a situation of the autonomous vehicle and traffic law data to the artificial intelligence algorithm,
perform machine learning of the input data, and
determine where the responsibility of the participants for the accident lies, based on results of the machine learning.

17. The traffic accident management device according to claim 16, wherein the processor is configured to:
further input past traffic accident history data to the artificial intelligence algorithm,
perform machine learning of the input data, and
determine where the responsibility of the participants for the accident lies, based on results of the machine learning.

18. The traffic accident management device according to claim 11, wherein the processor is configured to execute a routine for preventing a secondary accident following the accident.

19. The traffic accident management device according to claim 18, wherein the processor is configured to:
determine whether the autonomous vehicle is movable after occurrence of the accident;
generate an avoidance path of the autonomous vehicle; and
provide a control signal to enable the autonomous vehicle to travel along the avoidance path.

20. The traffic accident management device according to claim 19, wherein the processor is configured to:
calculate an estimated collision time taken for another vehicle following the autonomous vehicle to collide with the autonomous vehicle;
compare the estimated collision time with a avoidance time taken for the autonomous vehicle to avoid an accident site along the avoidance path; and
provide the control signal when the avoidance time is not shorter than the estimated collision time.
